(19) United States
(12) Patent Application Publication
(10) Pub. No.: US 2025/0393094 A1
(43) Pub. Date: Dec. 25, 2025

(54) USER EQUIPMENT CONNECTION MANAGEMENT SYSTEM IN NON-TERRESTRIAL NETWORKS

(71) Applicant: T-Mobile USA, Inc., Bellevue, WA (US)

(72) Inventors: Egil Gronstad, Bellevue, WA (US); Jun Liu, Sammamish, WA (US); Kun Lu, Bellevue, WA (US)

(21) Appl. No.: 18/750,912

(22) Filed: Jun. 21, 2024

(51) Int. Cl. H04W 76/27; H04B 7/185

(52) U.S. Cl. CPC H04W 76/27; H04B 7/18513

(57) ABSTRACT

A network device in a non-terrestrial network (NTN) receives information relating to an application or service being used by a terminal device that is in a connected mode with the network device. Subsequent to receiving the information, and in response to detecting an absence of additional information relating to the application or the service, the network device starts an RRC inactivity timer with a time period. The terminal device remains in the connected mode during the time period. The time period of the RRC inactivity timer is based on the application or the service being used by the terminal device. In response to the time period of the RRC inactivity timer expiring during the absence of the additional information during the time period, the terminal device is transitioned from a connected mode to an idle mode or an inactive mode with the network device.

### BACKGROUND

Current wireless communications systems utilize base stations to communicate with user equipment (UE). Base stations can be located at the surface of the Earth, and support telecommunications coverage in a surrounding area. When in a coverage region of the base station, a UE can connect with the base station to communicate data through the network. The fifth-generation mobile networks (5G and 5G Advanced) and the sixth-generation mobile system standard (6G) enable user equipment to communicate directly with an orbiting satellite. The user equipment can connect to a satellite when within a coverage region of the satellite. In general, a satellite can provide a larger coverage region and can more easily provide coverage to remote locations. Accordingly, network providers are utilizing non-terrestrial networks to increase coverage and provide improved networks. However, traditional systems can struggle to efficiently accommodate the unique characteristics of satellite networks, which often have a limited number of simultaneous connected users due to the large coverage areas of the satellite networks and limited satellite power.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3A is a block diagram illustrating an example wireless communications system that keeps a Radio Resource Control (RRC) inactivity timer off when there is a presence of uplink or downlink data between a network device of a non-terrestrial network and a user equipment (UE).

FIG. 3B is a block diagram illustrating an example wireless communications system that starts the RRC inactivity timer when there is an absence of uplink or downlink data between the network device of the non-terrestrial network and the UE.

FIG. 3C is a block diagram illustrating an example wireless communications system that releases an RRC connection between the network device of the non-terrestrial network and the UE when the RRC inactivity timer expires.

FIG. 4 is a flowchart that illustrates a process performed by a computer system in accordance with aspects of the present technology.

FIG. 5 is a block diagram illustrating an example environment of different RRC inactivity timers for different applications and services, in accordance with one or more implementations of this disclosure.

FIG. 6 is a high-level block diagram illustrating an example AI system, in accordance with one or more implementations.

FIG. 7 is a block diagram that illustrates an example of a computer system in which at least some operations described herein can be implemented.

The technologies described herein will become more apparent to those skilled in the art from studying the Detailed Description in conjunction with the drawings. Implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

New generations of wireless telecommunication networks, such as 5G, utilize satellites to improve network coverage. Given that satellites are not bound to the surface of the Earth, satellites can provide a larger coverage region than terrestrial base stations and more easily provide coverage in remote locations. As a consequence of this increased coverage region, a greater number of user devices may compete for communication resources provided by the satellite networks, thereby increasing congestion and use of the satellite's limited resources. Thus, satellite networks can be resource-constrained due to increased competition for limited communication resources. It is important to release those users as soon as possible when they are no longer to be severed.

Inactivity timers are used to manage the duration of connections between the satellite network and the user equipment during periods of data inactivity, helping to conserve battery power and alleviate network congestion. When a user equipment completes a data transmission session and ceases to transmit or receive information with the satellite network, the inactivity timer begins counting down. If no further data activity is detected before the expiration of the timer, the user equipment is released from the active connected mode to the idle mode. This dynamic management of UE connections based on inactivity timers allows cellular networks to adapt to fluctuating traffic conditions and efficiently allocate resources to active users. However, the conventional approach to inactivity timers in cellular networks employs fixed or uniform timer settings across all connections, irrespective of the communication needs and usage patterns of different applications and services.

In conventional systems where fixed timers are employed uniformly for all connections, even applications or services with sporadic data transmission requirements may be subjected to prolonged active connection times (e.g., the period that the user equipment consumes network resources), unnecessarily consuming valuable bandwidth and energy resources. This inefficiency may become particularly pronounced in scenarios where users engage in intermittent or burst data activities, such as messaging apps, IoT devices, or sensor networks, where data transmission occurs infrequently or in short bursts.

Moreover, the absence of application/service-aware timers can lead to lower quality user experiences and degraded service quality. For latency-sensitive applications, such as real-time voice or video communication, prolonged idle times between data transmissions can result in noticeable delays, jitter, and packet loss, impairing the overall quality of the communication session. Similarly, for emergency services like emergency calls or remote medical monitoring, any delay in data transmission due to excessive idle periods may have severe consequences, compromising user safety due to system unreliability.

Furthermore, without adaptive timers tailored to the communication requirements of different applications and services, non-terrestrial networks may struggle to manage network congestion and allocate resources efficiently. In scenarios where multiple applications with varying data transmission patterns coexist within the network, the lack of application-aware timers can exacerbate congestion issues, leading to increased latency, packet collisions, and degraded throughput for all users. This congestion not only affects the performance of individual applications but also decreases the overall network efficiency and capacity utilization, lowering the ability of non-terrestrial networks to accommodate growing user demands and scale effectively. Additionally, the scalability of satellite networks is limited since the power resource of a satellite network is solar power, which is a limited resource. Keeping devices in a connected mode when the device is not transmitting or receiving information with the satellite network wastes the limited resource (e.g., solar power).

This document discloses methods, systems, and apparatuses for managing the connection state between terminal devices and a network device in a non-terrestrial network based on the applications or services being used by the terminal device. In some implementations, the network device adjusts Radio Resource Control (RRC) inactivity timers based on the specific requirements of each application or service being used by terminal devices. Upon receiving information relating to the application or service in use, a network device in the non-terrestrial network initiates an RRC inactivity timer with a time period based on the characteristics of the application or service. During this time period, the terminal device remains in a connected mode with the network device, allowing for seamless communication. Upon expiration of the RRC inactivity timer without the presence of additional information relating to the application or service, the system proceeds to transition the terminal device from the connected mode to either an idle mode or an inactive mode with the network device. Releasing the terminal device from the connected mode ensures that network resources are efficiently used and that the terminal device no longer maintains an active connection when not actively engaged in data transmission or reception.

In some implementations, the network device uses machine learning (ML) models to identify patterns in traffic between the network device and the terminal device, enabling dynamic adjustments to the assigned time period of the RRC inactivity timer in response to changes in traffic patterns. In some implementations, the network device further enhances network efficiency by preventing premature release of terminal devices during burst traffic scenarios, where intermittent surges in data transmission occur. Rather, the network device can exchange information with neighboring network devices and adjust RRC inactivity timers accordingly. In some implementations, the system generates service profiles associated with specific types of applications or services, where each service profile includes predetermined parameters for adjusting the assigned time period of the RRC inactivity timer based on the associated application or service.

The benefits and advantages of the implementations described herein include addressing the inefficiencies inherent in conventional systems by introducing application/service-aware timers that adapt dynamically to the communication requirements of different applications and services. By tailoring the idle time based on the specific data transmission patterns of each application or service, the system ensures that terminal devices are only kept in the connected mode for the necessary duration. The targeted approach prevents unnecessary idle times, conserving valuable network bandwidth and energy resources, and mitigating the impact of sporadic or burst data activities.

Moreover, the introduction of application/service-aware timers enhances the user experience and service quality by reducing latency and improving responsiveness, particularly for latency-sensitive applications like real-time voice or video communication. By minimizing idle times between data transmissions, the system ensures that data is delivered promptly, without noticeable delays, jitter, or packet loss, thereby enhancing the overall quality and reliability of communication sessions.

Furthermore, the adaptive nature of the timers enables non-terrestrial networks to manage network congestion more effectively and allocate resources dynamically based on real-time demands. By adjusting the idle time according to the communication requirements of different applications and services, the system helps alleviate congestion issues and improve resource utilization within the network. The approach not only improves the performance of individual applications but also enhances the overall network efficiency and capacity utilization, enabling non-terrestrial networks to accommodate growing user demands and scale effectively in response to changing traffic patterns.

The methods disclosed herein can cause a reduction in greenhouse gas emissions compared to traditional methods for operating telecommunication networks. Every year, approximately 40 billion tons of CO² are emitted around the world. For example, the average U.S. power plant expends approximately 600 grams of carbon dioxide for every kWh generated. Power consumption by digital technologies including telecommunications networks account for approximately 4% of this figure. Further, conventional user device and application settings can sometimes exacerbate the causes of climate change. The implementations disclosed herein for conserving network resources can mitigate climate change by reducing and/or preventing additional greenhouse gas emissions into the atmosphere. For example, releasing idle terminal devices from connections with the network device using dynamic inactivity timers to avoid unnecessary data communication as described herein reduces electrical power consumption and the amount of data downloaded/uploaded compared to traditional methods for operating fixed inactivity timers. In particular, by using inactivity times based on the application or service used by the terminal device, the disclosed systems provide increased efficiency compared to traditional methods.

Moreover, in the U.S., datacenters are responsible for approximately 2% of the country's electricity use, while globally they account for approximately 200 terawatt Hours (TWh). Transferring 1 GB of data can produce approximately 3 kg of CO². Each GB of data downloaded thus results in approximately 3 kg of CO² emissions or other greenhouse gas emissions. The storage of 100 GB of data in the cloud every year produces approximately 0.2 tons of CO² or other greenhouse gas emissions. Managing the connections between the terminal device and the network device of a non-terrestrial network using dynamic inactivity timers according to the embodiments disclosed herein reduces the amount of data downloaded, and obviates the need for wasteful CO² emissions. Therefore, the disclosed implementations for using dynamic inactivity timers on satellite networks mitigates climate change and the effects of climate change by reducing the amount of data stored and downloaded in comparison to conventional network technologies.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

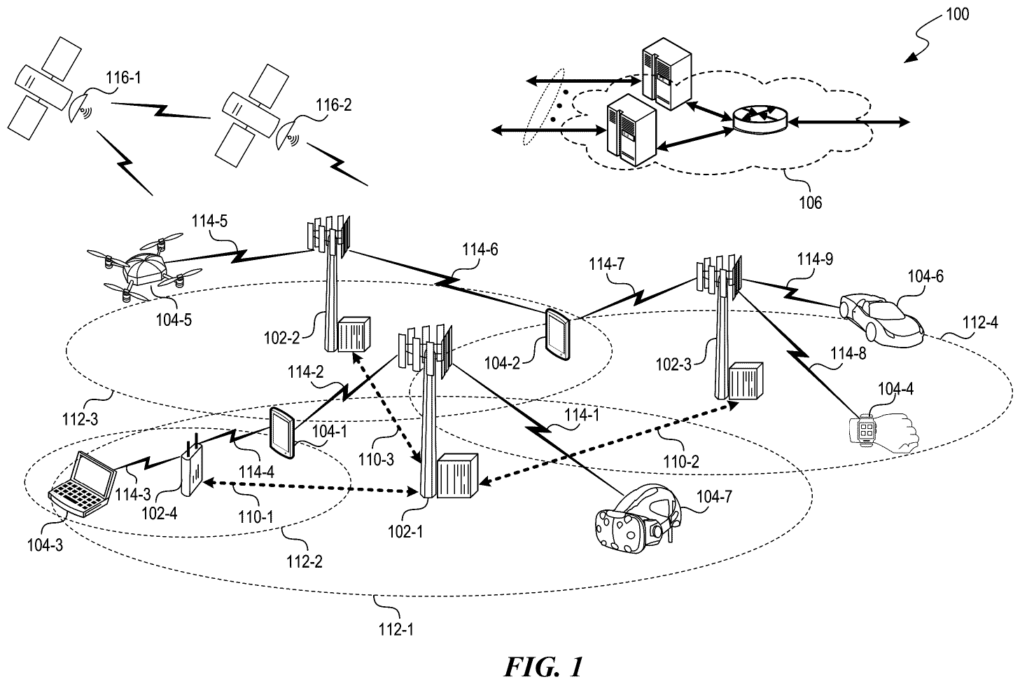

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 602.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces for LTE) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., Xn interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IOT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; loT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a non-terrestrial network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

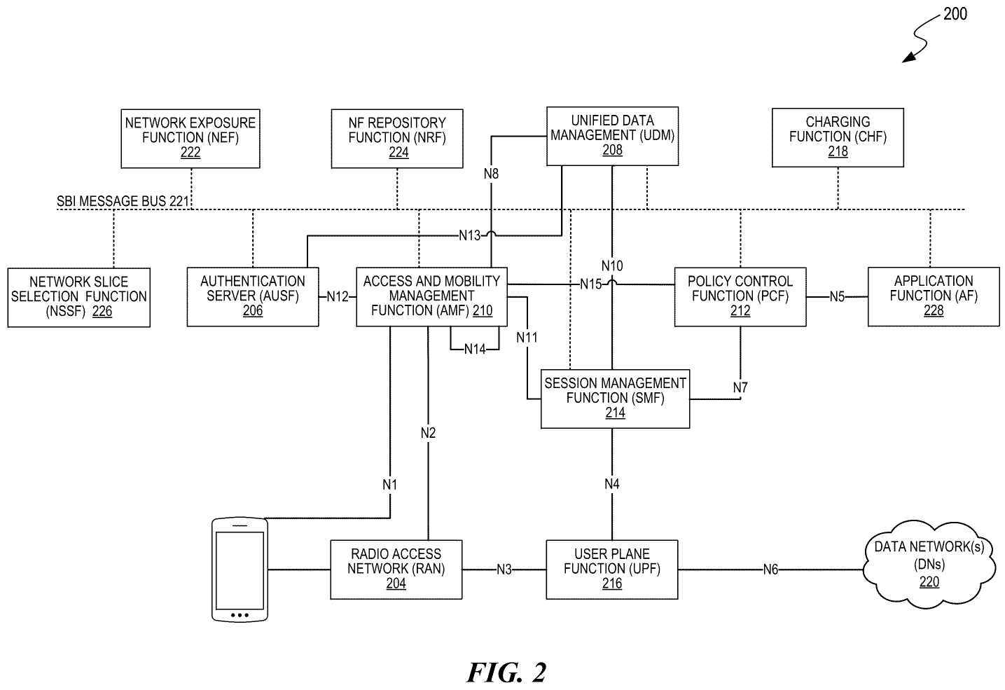

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNS) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### UE Connection Management System

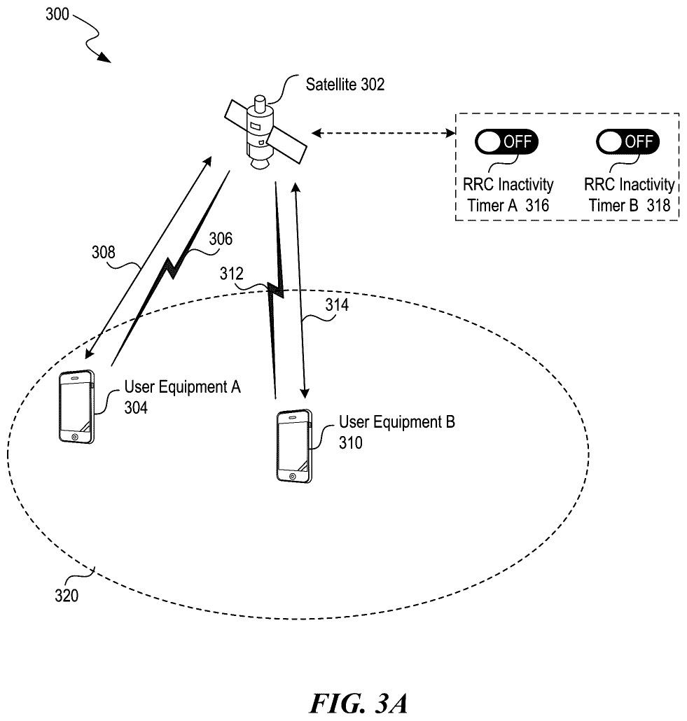

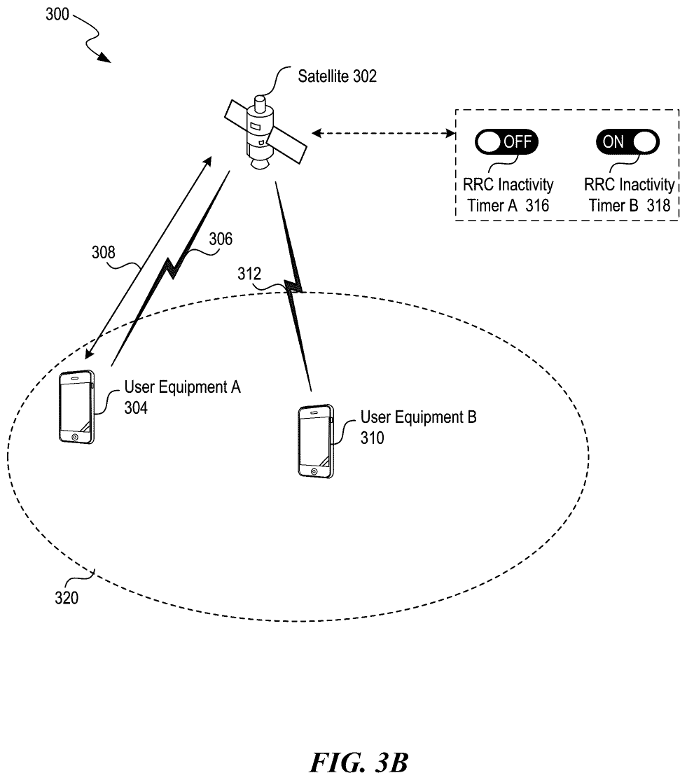

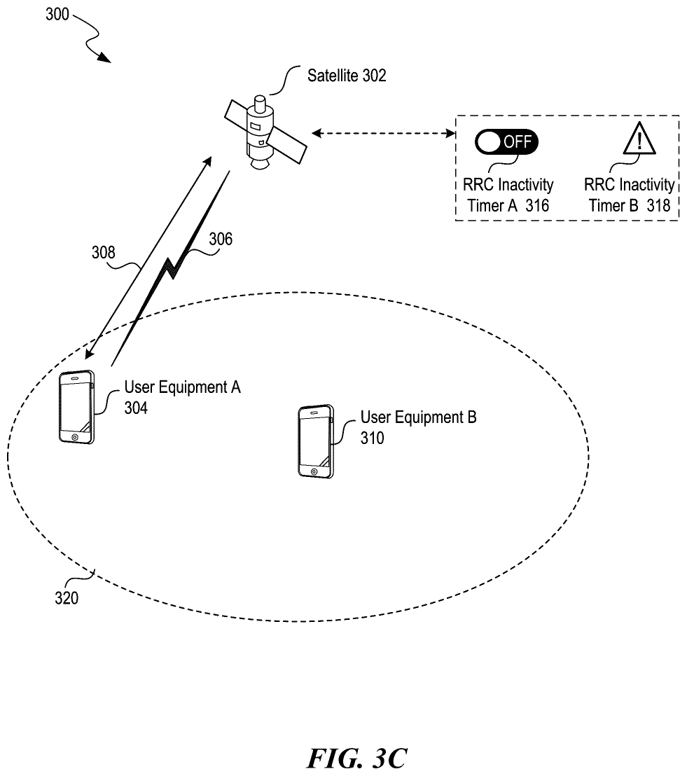

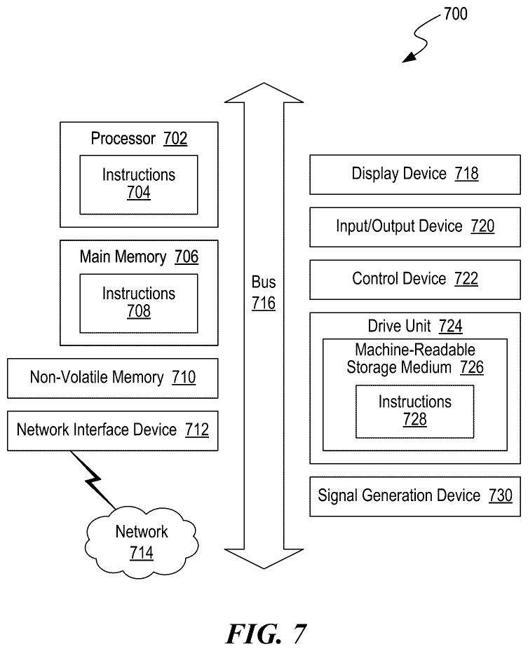

FIG. 3A is a block diagram illustrating an example wireless communications system 300 that keeps a Radio Resource Control (RRC) inactivity timer off when there is a presence of uplink or downlink data between a network device of a non-terrestrial network (NTN) (sometimes referred to as a satellite network) and a user equipment (UE). A non-terrestrial network can, as an alternative to satellite 302, include high-altitude platforms (HAPs), such as stratospheric balloons, blimps, or the like. The wireless communications system 300 is implemented using components of the example computer system 700 illustrated and described in more detail with reference to FIG. 7. For example, the wireless communications system 300 can be implemented using processor 702 and instructions 708 programmed in the memory 706 illustrated and described in more detail with reference to FIG. 7. Likewise, implementations of the wireless communications system 300 can include different and/or additional components or be connected in different ways.

In some examples, the wireless communications system 300 implements aspects of the wireless telecommunications network 100 illustrated and described in more detail with reference to FIG. 1. The wireless communications system 300 includes satellite 302, UE 304, 310, RRC connection 306, 312, communication data 308, 314, and RRC inactivity timer 316, 318. Satellite 302 and UE 304, 310 are examples of the corresponding devices illustrated and described in more detail with reference to FIG. 1. Satellite 302 is the same as or similar to satellites 116-1 and 116-2 in FIG. 1. A geographical area associated with a transmission beam of satellite 302 is sometimes called a beam footprint 320, and UE 304, 310 can communicate with the satellite 302 while the UE 304, 310 is located within the beam footprint 320.

Within the beam footprint 320, UEs 304, 310 can send and/or receive communication data 308, 314 with the satellite 302 related to particular applications and services. Communication data 308, whether uplink or downlink, refers to transmitted information between a UE (e.g., UE 304, 310) and a network device, such as a satellite (e.g., satellite 302) in a non-terrestrial network. Uplink data is the information sent from the UE to the network device. Uplink data may include various types of data such as sensor readings, user commands, application data, or any other information that the UEs 304, 310 need to transmit to the network of the network device for processing, storage, or further communication. Downlink data, on the other hand, is the information sent from the network device to the UE. Downlink data may consist of responses to user commands, updates, notifications, streaming content, or any other data that the network delivers to the UEs 304, 310 for user consumption or device operation.

The RRC protocol can control the establishment and maintenance of RRC connections 306, 312 within the wireless communications system 300. As a layer 3 protocol operating within the air interface of wireless telecommunications networks, the RRC protocol governs the signaling procedures necessary for initiating, configuring, and releasing RRC connections between UEs and the non-terrestrial network represented by the satellite 302. RRC connections 306, 312 are a dedicated link established between the UEs 304, 310 and the satellite 302 to facilitate the exchange of control and user data. Specifically, RRC connections 306, 312 can enable the transmission of various types of data, including signaling messages that help configure the UE's 304, 310 communication parameters, manage mobility, and manage the use of network resources. By maintaining the RRC connections 306, 312, the RRC protocol ensures that the UE 304, 310 and the satellite 302 can communicate effectively.

When a UE, such as UE 304, 310, requests to connect with the satellite 302, the RRC protocol selects connection parameters, such as radio resource allocation and transmission modes, to ensure efficient and reliable data (e.g., communication data 308) exchange. Throughout the RRC connection 306, 312, the RRC protocol monitors the quality of the radio link, facilitates handovers between different cells or beams within the satellite's coverage area, and coordinates transitions between different connection states, such as idle, connected, and standby modes.

In idle mode, a UE is not actively engaged in communication data transmission but remains registered with the network. This state allows the UE to conserve battery power by minimizing the UE's activity while still being reachable for incoming communications. In idle mode, the UE periodically listens for paging messages from the network, and can notify the UE of incoming calls, messages, or other notifications. Connected mode, in contrast, is when the UE is actively engaged in data transmission with the network. In this state, the RRC protocol manages the continuous exchange of data packets, ensuring robust and stable communication. The UE in connected mode frequently interacts with the network. The RRC protocol monitors the quality of the radio link and facilitates necessary adjustments to increase or maintain data throughput and minimize latency. Additionally, the RRC protocol handles handovers between different cells or beams within the satellite's coverage area. In standby mode, sometimes known as inactive mode, the UE is not actively transmitting data but maintains a semi-active connection with the network. Standby mode allows for quicker resumption of active communication compared to idle mode, as the UE retains some context and state information. For example, standby mode can be useful for applications with intermittent data transmission needs, such as loT devices or messaging apps, where data packets are sent sporadically.

Additionally, the RRC protocol governs the behavior of RRC inactivity timers 316, 318, which regulate the duration of idle periods between data transmissions. RRC inactivity timers 316, 318 conserve network resources by releasing resources allocated to UE connections when no data exchange is occurring. For example, in FIG. 3A, UE 304 (e.g., “User Equipment A”) has a corresponding RRC inactivity timer 316 (e.g., “RRC Inactivity Timer A”), and UE 310 (e.g., “User Equipment B”) has a corresponding RRC inactivity timer 318 (e.g., “RRC Inactivity Timer B”). The RRC inactivity timers 316, 318 are designed to regulate the amount of time a user equipment (UE) connection ceases to transmit or receive data with the network infrastructure, such as satellite 302.

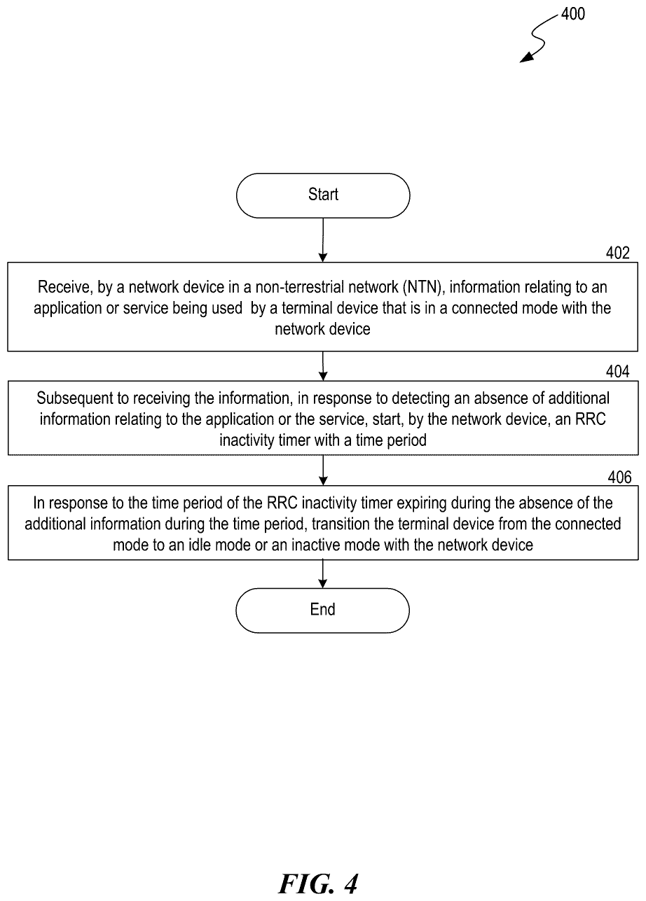

When the UE 304, 310 establishes a connection with the network, the RRC inactivity timer 316, 318 begins its countdown, where the duration of the inactivity timer 316 countdown is associated with the service or application (discussed in further detail with reference to FIG. 4). During this period, if no data is exchanged between the UE 304, 310 and the network (e.g., satellite 302), the RRC inactivity timer 316, 318 continues to decrement until the RRC inactivity timer 316, 318 reaches a predefined threshold. Once the threshold is met, the RRC inactivity timer 316, 318 triggers an action, such as releasing the UE 304, 310 from the RRC connection 306, 312 or transitioning the RRC connection 306, 312 to a lower power state to conserve resources. For example, in FIG. 3A, communication data 308, 314 are actively being transmitted between the UEs and the satellite. As long as there is an ongoing exchange of uplink or downlink data, the RRC inactivity timers 316, 318 remain off, maintaining the UEs in a connected mode.

FIG. 3B is a block diagram illustrating an example wireless communications system 300 that starts the RRC inactivity timer 318 when there is an absence of uplink and/or downlink data (e.g., communication data 314) between the network device (e.g., satellite 302) of the non-terrestrial network and the UE 310. An example satellite 302 and UEs 304, 310 are illustrated and described in more detail with reference to FIG. 1 and FIG. 3A.

The system continuously monitors the communication channel between the network device, such as satellite 302, and the terminal device, such as UE 310. Monitoring the communication channel allows the system to detect the presence or absence of uplink and downlink data transmissions. When there is an absence of communication data 314, such as uplink or downlink data transmissions, indicating a period of data inactivity, the system identifies the condition as a trigger for activating the RRC inactivity timer. For example, in FIG. 3B, when the system identifies that no data is being exchanged, the system activates the RRC inactivity timer 318. Activating the RRC timer 318 process ensures that network resources are not wasted on maintaining idle connections and allows the network to dynamically allocate bandwidth and processing power to other active connections and services.

The RRC inactivity timer, managed by the RRC protocol, begins a countdown indicating an idle period within the connection between satellite 302 and UE 310. The system continually monitors the status of the RRC inactivity timer 318 as the RRC inactivity timer's 318 countdown progresses. During this phase, the RRC inactivity timer 318 can operate independently of other RRC inactivity timers (e.g., RRC inactivity timer 316), only tracking the elapsed time since the last data transmission occurred between the satellite 302 and the corresponding UE 310. The independence allows each timer to specifically track the elapsed time since the last data transmission occurred between the satellite 302 and its corresponding UE. By doing so, the system can provide a tailored approach to managing UE connections, ensuring that each UE's connection status is handled based on the corresponding UE's specific communication data activity.

FIG. 3C is a block diagram illustrating an example wireless communications system 300 that releases an RRC connection 312 between the network device, such as the satellite 302 of the non-terrestrial network and the terminal device, such as the UE 310, when the RRC inactivity timer 318 expires. An example satellite 302 and UE 304, 310 are illustrated and described in more detail with reference to FIG. 1 and FIG. 3A.

While the RRC inactivity timer 318 is active, the system evaluates whether the expiration conditions have been met. Specifically, the system assesses whether the elapsed idle time exceeds the predefined threshold. This threshold can be determined based on various factors, such as the type of application or service being used by the UE, the overall network traffic, and the desired balance between resource utilization and user experience. Methods of determining the threshold are discussed with reference to FIG. 4.

If the RRC inactivity timer 318 expires without any data transmission occurring between the satellite and the UE during the idle period, the system interprets this as an indication that the UE 310 is no longer actively transmitting or receiving data. This prompts the system to initiate the release action, such as releasing the non-active UE 310 from the RRC connection 312 to the non-terrestrial network, transitioning the RRC connection 312 to a lower power state, or performing other resource management tasks to improve network efficiency. The transition helps free up valuable network resources that can be allocated to other active UEs (e.g., UE 304), thus improving the overall efficiency and capacity of the non-terrestrial network.

FIG. 4 is a flowchart that illustrates a process 400 performed by a computer system in accordance with aspects of the present technology. In some implementations, the process 400 is performed by components of example wireless devices 104 illustrated and described in more detail with reference to FIG. 1. Likewise, implementations can include different and/or additional steps or can perform the steps in different orders.

In act 402, the system receives, by a network device in a non-terrestrial network, information relating to an application or service being used by a terminal device (e.g., UEs 304, 310 in FIGS. 3A-3C) that is in a connected mode with the network device (e.g., satellite 302 in FIGS. 3A-3C). The network device is the same as or similar to satellite 302 illustrated and described in more detail with reference to FIG. 3A. The terminal device is the same as or similar to UE 304, 310 illustrated and described in more detail with reference to FIG. 3A. The network device can detect the RRC connection between the UE and the network device. The connected mode can be managed by an RRC protocol. The connected mode is discussed in further detail with reference to FIG. 3A. Examples of an RRC protocol are described with reference to FIGS. 3A-3C. For example, the information can include uplink data transmission of the application or the service. The uplink data transmission is transmitted from the terminal device (e.g., UEs 304, 310 in FIGS. 3A-3C) to the network device (e.g., satellite 302). Additionally, the information can include a request for downlink data transmission of the application or the service. The downlink data transmission is transmitted from the network device to the terminal device. Further examples of uplink and downlink transmissions are described with reference to FIG. 3A.

In some implementations, the system manages the connected mode using Frequency Division Duplexing (FDD). FDD uses two frequency bands to simultaneously transmit data on a first frequency band and receive the data on a second frequency band. The time period of the RRC inactivity timer can be based on the two frequency bands. The two distinct frequency bands can include: a frequency band for uplink data transmission from the UE to the network device, such as the satellite 302, and a frequency band for downlink data reception from the network device to the UE. The separation allows for simultaneous bidirectional communication, which improves the efficiency and reliability of data transmission. By using separate frequency bands for uplink and downlink, FDD minimizes the risk of interference and ensures a consistent communication channel since there is no contention or switching required between transmitting and receiving on the same frequency. Since FDD allows for continuous and concurrent data transmission and reception, the system can set different RRC inactivity timer periods based on the activity observed on each frequency band. For example, if the uplink frequency band experiences intermittent data bursts while the downlink remains consistently active, the system can configure the RRC inactivity timer to accommodate these patterns, ensuring that the UE is not prematurely released from the connected mode due to idle periods on one band while the other remains active.

In some implementations, the system can dynamically adjust the RRC inactivity timer based on real-time monitoring of both frequency bands. This involves assessing the data transmission rates, the frequency of data bursts, and/or the duration of idle periods separately for the uplink and downlink bands. For example, if the system detects that one frequency band is experiencing prolonged inactivity while the other frequency band is still transmitting or receiving data, the system can prolong the RRC inactivity timer to prevent unnecessary disconnection. For example, a video streaming application heavily utilizes the downlink frequency band for continuous data reception, while the uplink band is used sporadically for control signals or occasional data uploads. The system, using FDD, can set a longer inactivity timer for the downlink band due to its consistent activity, while maintaining a shorter timer for the uplink band. If the uplink band goes idle, the system may not immediately terminate the connection, recognizing that the primary data flow is still active on the downlink.

In act 404, subsequent to receiving the information, in response to detecting an absence of additional information relating to the application or the service, the system starts, by the network device, an RRC inactivity timer with a time period. The terminal device remains in the connected mode during the time period. The time period of the RRC inactivity timer is based on the application or the service being used by the terminal device.

For example, the additional information can include additional uplink data transmission of the application or the service. Similarly to the uplink data transmission, the additional uplink data transmission is transmitted from the terminal device to the network device. Additionally, the information can include additional downlink data transmission of the application or the service. Similarly to the downlink data transmission, the additional downlink data transmission is transmitted from the terminal device to the network device. Further examples of additional uplink and additional downlink transmissions are described with reference to FIGS. 3A-3C.

The system's evaluation of the expiration conditions involves monitoring the progress of the RRC inactivity timer 318 and comparing the elapsed time against the predefined threshold. If the timer reaches or exceeds this threshold without detecting any additional uplink or downlink data, the system interprets this as a sign that the UE 310 is no longer actively transmitting or receiving data. This prompts the system to initiate the release action, transitioning the UE from the connected mode to an idle or inactive mode. This transition helps free up valuable network resources that can be allocated to other active UEs, thus improving the overall efficiency and capacity of the non-terrestrial network (NTN).

The system can take into consideration the specific requirements and characteristics of the applications or services being used by the UE. For example, in some implementations, the system receives burst traffic from the UE. The burst traffic can include intermittent surges in the uplink data. The network device, in response to receiving the burst traffic, prevents the release of the UE from the RRC connection to the network device.

For instance, applications that involve bursty or intermittent data transmissions may require longer inactivity timers to accommodate potential future data bursts without prematurely disconnecting the UE. Conversely, applications that involve continuous data streams might have shorter inactivity timers to quickly release the connection when the data flow ceases. By tailoring the inactivity timers to the needs of different applications and services, the system can maintain connectivity while conserving network resources. For example, the system can collect data on the frequency, duration, and volume of data packets being sent and received between a UE and a network device. Metrics, such as inter-arrival time, variance, standard deviation, and peak-to-average ratio, can be used to detect fluctuations and irregularities in data transmission rates. For instance, bursty traffic typically exhibits long periods of inactivity followed by short bursts of high activity, and can be discerned through high variance and standard deviation in packet arrival times and a high peak-to-average ratio.

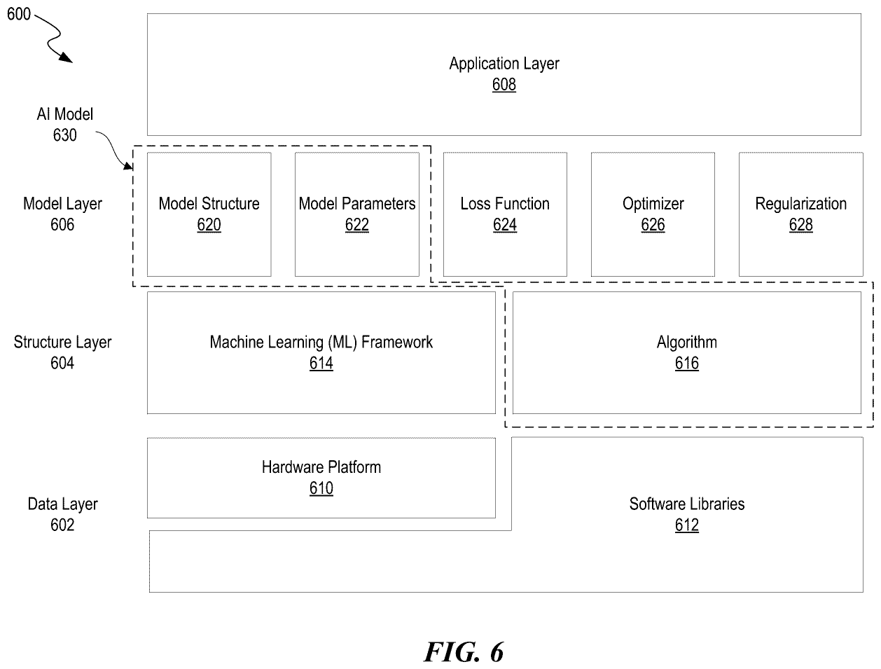

In some implementations, the system determines the assigned time period of the RRC inactivity timer by employing a machine-learning (ML) model to identify patterns in traffic between the network device and the UE. The system dynamically adjusts the assigned time period of the RRC inactivity timer based on changes in the identified patterns. In some implementations, ML models trained on labeled datasets of both bursty and non-bursty traffic are used in determining whether an application or service is bursty. The ML models can use features such as packet arrival times, data volume over time, idle periods, and traffic peaks to recognize bursty traffic patterns. For example, the ML model can detect long idle periods interspersed with short, intense data transmissions, characteristic of bursty traffic. Further methods of training an ML model are discussed with reference to FIG. 6.

The system can maintain application profiles that include predefined characteristics of typical traffic patterns for various applications and services. For example, messaging apps, loT devices, and sensor networks, can be assigned as bursty. When the system detects traffic patterns that align with these profiles, it classifies the application as bursty. The system can dynamically adjust its classification if the traffic pattern changes. For instance, an application initially deemed non-bursty may be reclassified if it starts exhibiting bursty behavior. For example, the system observes long periods of no data transmission followed by short bursts when messages are sent or received. The high variance in packet arrival times and a high peak-to-average ratio indicate bursty traffic. The ML model, trained on similar traffic patterns, can confirm this classification. Consequently, the system adjusts the RRC inactivity timer to accommodate the bursty nature of the application, preventing premature release of the connection during idle periods between data bursts.

In some implementations, the system can dynamically adjust the predefined threshold based on real-time network conditions and user behavior further enhances its adaptability and efficiency. For example, during periods of high network congestion, the system can reduce the RRC inactivity timer thresholds to quickly release idle connections and alleviate congestion. Conversely, during periods of low network activity/congestion, the system can extend the RRC inactivity timer thresholds to provide a more consistent user experience. The system can respond to varying network conditions and user demands in a flexible manner.

In act 406, in response to the time period of the RRC inactivity timer expiring during the absence of the additional information during the time period, the system transitions the terminal device from the connected mode to an idle mode or an inactive mode with the network device. Similar to the connected mode, the idle mode and the inactive mode can be managed by the RRC protocol.

In some implementations, the system can generate service profiles associated with specific types of applications and/or specific types of services. Each service profile can include predetermined parameters for adjusting the time period of the RRC inactivity timer based on the associated application or the associated service. The service profiles can capture the unique communication patterns and requirements of various applications and services. For instance, a messaging app may use frequent but short bursts of data transmission, while a video streaming service uses continuous high-bandwidth downlink transmission. By generating tailored service profiles for different types of applications and/or services, the system can tailor the management of RRC inactivity timers to suit the specific needs of each application or service.

Each service profile can include predetermined parameters that dictate how the RRC inactivity timer should be adjusted based on the associated application's or service's behavior. The parameters can include factors such as typical data transmission intervals, expected idle periods, and the importance of maintaining a continuous connection. For example, a service profile for a real-time video conferencing application might set a shorter inactivity timer to quickly resume data transmission and avoid interruptions, while a profile for an Internet of Things (IOT) sensor might allow for longer idle periods between data bursts, reflecting its sporadic communication pattern. The system can dynamically select and apply the service profiles as needed. When a UE initiates a connection with the network device, the system can identify the type of application or service being used and apply the corresponding service profile. As the UE continues communicating with the network device, the system can further refine and update the timer settings based on real-time data.

In some implementations, the service profiles allow the system to handle multiple applications or services concurrently, each with its tailored RRC inactivity timer settings. For instance, in an environment where multiple UEs are connected to a satellite network, each running different applications, the system can simultaneously manage several service profiles. A user streaming a live sports event can maintain an uninterrupted downlink with a short inactivity timer, while another user sending periodic updates from an loT device can have a longer inactivity timer without affecting the network's overall efficiency.

In some implementations, the system communicates with a neighboring network device in the non-terrestrial network to exchange information related to the received burst traffic of the network device or the neighboring network device. Neighboring refers to network devices or nodes that are geographically proximate or logically connected within the network architecture. The neighboring devices can include satellites, ground stations, or other components that form part of the non-terrestrial network infrastructure. Neighboring network devices can exchange various types of information, including traffic patterns, signal strength, channel conditions, and resource availability. Furthermore, neighboring nodes can collaborate on tasks such as load balancing, spectrum management, and interference mitigation to improve the utilization of network resources and improve service quality for connected users.

The system adjusts the RRC inactivity timer based on the exchanged information. By exchanging information on burst traffic, network devices can collectively assess the current load and demand on the network resources. For example, if one network device detects a significant surge in data transmission from a group of UEs, it can relay this observation to neighboring devices, indicating a potential increase in network congestion or resource contention. Similarly, network devices can share insights into periods of relative calm or reduced activity. Based on the exchanged information, the system dynamically adjusts the RRC inactivity timers employed by network devices to reflect the current network conditions and traffic patterns. For instance, if neighboring devices identify a period of heightened burst activity across the non-terrestrial network, the neighboring devices may collectively opt to shorten the RRC inactivity timers to ensure prompt responsiveness and minimize idle periods between data transmissions. Conversely, during periods of low activity or when burst traffic subsides, the system may extend the inactivity timers to conserve energy and resources while maintaining connectivity.

Releasing the terminal device (e.g., a user equipment) from the connected mode (e.g., an RRC connection to the network device) in response to the expiration of the RRC inactivity timer reduces electrical power consumption and the volume of data transmitted by dynamically managing the connection state of the terminal device based on actual data transmission activity rather than maintaining a constant connection regardless of data flow. Specifically, the system uses dynamically adjusted RRC inactivity timers to monitor the activity of uplink and downlink data transmissions. When these RRC inactivity timers, assigned based on the type of application or service in use, reach their predefined thresholds without detecting additional data, they trigger the release of the terminal device from the active RRC connection. This release mechanism ensures that the terminal device does not remain in a power-intensive connected state during periods of inactivity. By transitioning the terminal device to an idle or inactive state, the system conserves battery life, as the idle state consumes significantly less power than the active connected state. This is particularly beneficial for battery-powered devices such as smartphones and IoT devices, where power management is used for prolonging device operation and improving user experience.

In addition to reducing power consumption, this approach also minimizes unnecessary data transmissions. When the terminal device is released from the RRC connection, the terminal device stops transmitting keep-alive messages and other control data that would otherwise be required to maintain the active connection. This reduction in control data transmission not only conserves network bandwidth but also reduces the processing load on both the terminal device and the network infrastructure.

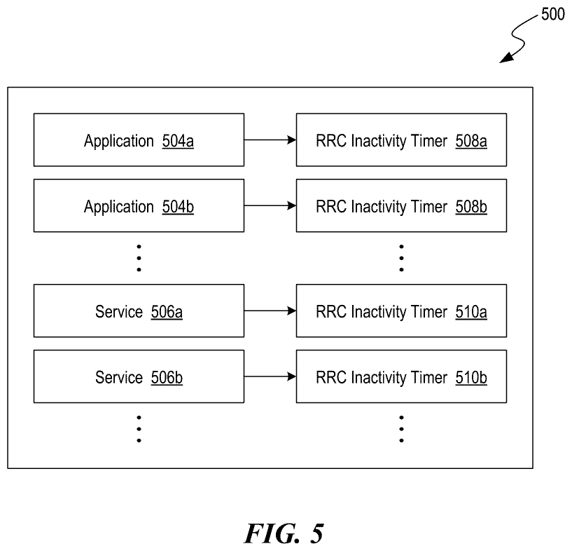

FIG. 5 is a block diagram illustrating an example environment 500 of different RRC inactivity timers for different applications and services, in accordance with one or more implementations of this disclosure. Environment 500 includes applications 504a, 504b, services 506a, 506b, and RRC inactivity timers 508a, 508b, 510a, 510b. RRC inactivity timers 508a, 508b, 510a, 510b is the same as or similar to RRC inactivity timers 316, 318 illustrated and described in more detail with reference to FIGS. 3A-3C. Likewise, implementations of example environment 500 can include different and/or additional components or can be connected in different ways.

The applications 504a, 504b can represent a variety of user-driven functionalities, ranging from latency-sensitive real-time communications to intermittent data transfers. Latency-sensitive applications, such as voice calls and video streaming services, prioritize real-time data transmission to ensure consistent communication experiences with minimal delays. These applications rely on timely data delivery and rely on efficient network protocols to maintain smooth connections between users. Conversely, intermittent data transfers characterize applications like messaging platforms, file downloads, and background synchronization services. These applications exhibit sporadic data transmission patterns, with data exchanges occurring intermittently and varying in duration and frequency. While intermittent data transfers may not require real-time responsiveness, intermittent data transfers still rely on reliable network connectivity and efficient data delivery mechanisms to ensure timely transmission and reception of information. Each application can impose different timings and durations of data transmissions.

Similarly, the services 506a, 506b includes a variety of network-based offerings, including offerings such as voice services, data services, and/or multimedia content delivery. Voice services enable users to engage in real-time conversations. Data services allow users to access and exchange information, browse the internet, and/or interact with online applications and services. Multimedia content delivery services can include, for example, streaming video, music, or gaming.

The RRC inactivity timers 508a, 508b, 510a, 510b can be assigned to the corresponding applications and services to accommodate the specific requirements and characteristics of the corresponding applications and services. By assigning separate RRC inactivity timers 508a, 508b, 510a, 510b to each application 504a, 504b and service 506a, 506b, the system can accommodate the specific communication patterns, data transmission frequencies, and latency sensitivities associated with different types of applications and services. Methods of determining the parameters of particular RRC timers are described with reference to FIG. 4.

### AI System

FIG. 6 is a block diagram illustrating an example artificial intelligence (AI) system 600, in accordance with one or more implementations of this disclosure. The AI system 600 is implemented using components of the example computer system 700 illustrated and described in more detail with reference to FIG. 7. For example, the AI system 600 can be implemented using the processor 702 and instructions 708 programmed in the memory 706 illustrated and described in more detail with reference to FIG. 7. Likewise, implementations of the AI system 600 can include different and/or additional components or be connected in different ways.

As shown, the AI system 600 can include a set of layers, which conceptually organize elements within an example network topology for the AI system's architecture to implement a particular AI model 630. Generally, an AI model 630 is a computer-executable program implemented by the AI system 600 that analyzes data to make predictions. Information can pass through each layer of the AI system 600 to generate outputs for the AI model 630. The layers can include a data layer 602, a structure layer 604, a model layer 606, and an application layer 608. The algorithm 616 of the structure layer 604 and the model structure 620 and model parameters 622 of the model layer 606 together form the example AI model 630. The optimizer 626, loss function engine 624, and regularization engine 628 work to refine and optimize the AI model 630, and the data layer 602 provides resources and support for application of the AI model 630 by the application layer 608.

The data layer 602 acts as the foundation of the AI system 600 by preparing data for the AI model 630. As shown, the data layer 602 can include two sub-layers: a hardware platform 610 and one or more software libraries 612. The hardware platform 610 can be designed to perform operations for the AI model 630 and include computing resources for storage, memory, logic, and networking, such as the resources described in relation to FIG. 7. The hardware platform 610 can process amounts of data using one or more servers. The servers can perform backend operations such as matrix calculations, parallel calculations, machine learning (ML) training, and the like. Examples of servers used by the hardware platform 610 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but can be used for AI applications due to their vast computing and memory resources. GPUs use a parallel structure that generally makes their processing more efficient than that of CPUs. In some instances, the hardware platform 610 can include Infrastructure as a Service (IaaS) resources, which are computing resources, (e.g., servers, memory, etc.) offered by a cloud services provider. The hardware platform 610 can also include computer memory for storing data about the AI model 630, application of the AI model 630, and training data for the AI model 630. The computer memory can be a form of random-access memory (RAM), such as dynamic RAM, static RAM, and non-volatile RAM.

The software libraries 612 can be thought of as suites of data and programming code, including executables, used to control the computing resources of the hardware platform 610. The programming code can include low-level primitives (e.g., fundamental language elements) that form the foundation of one or more low-level programming languages, such that servers of the hardware platform 610 can use the low-level primitives to carry out specific operations. The low-level programming languages do not require much, if any, abstraction from a computing resource's instruction set architecture, allowing them to run quickly with a small memory footprint. Examples of software libraries 612 that can be included in the AI system 600 include Intel Math Kernel Library, Nvidia cuDNN, Eigen, and Open BLAS.

The structure layer 604 can include a machine learning (ML) framework 614 and an algorithm 616. The ML framework 614 can be thought of as an interface, library, or tool that allows users to build and deploy the AI model 630. The ML framework 614 can include an open-source library, an application programming interface (API), a gradient-boosting library, an ensemble method, and/or a deep learning toolkit that work with the layers of the AI system facilitate development of the AI model 630. For example, the ML framework 614 can distribute processes for application or training of the AI model 630 across multiple resources in the hardware platform 610. The ML framework 614 can also include a set of pre-built components that have the functionality to implement and train the AI model 630 and allow users to use pre-built functions and classes to construct and train the AI model 630. Thus, the ML framework 614 can be used to facilitate data engineering, development, hyperparameter tuning, testing, and training for the AI model 630.

Examples of ML frameworks 614 or libraries that can be used in the AI system 600 include TensorFlow, PyTorch, Scikit-Learn, Keras, and Cafffe. Random Forest is a machine learning algorithm that can be used within the ML frameworks 614. LightGBM is a gradient boosting framework/algorithm (an ML technique) that can be used. Other techniques/algorithms that can be used are XGBoost, CatBoost, etc. Amazon Web Services is a cloud service provider that offers various machine learning services and tools (e.g., Sage Maker) that can be used for platform building, training, and deploying ML models.

In some implementations, the ML framework 614 performs deep learning (also known as deep structured learning or hierarchical learning) directly on the input data to learn data representations, as opposed to using task-specific algorithms. In deep learning, no explicit feature extraction is performed; the features of feature vector are implicitly extracted by the AI system 600. For example, the ML framework 614 can use a cascade of multiple layers of nonlinear processing units for implicit feature extraction and transformation. Each successive layer uses the output from the previous layer as input. The AI model 630 can thus learn in supervised (e.g., classification) and/or unsupervised (e.g., pattern analysis) modes. The AI model 630 can learn multiple levels of representations that correspond to different levels of abstraction, wherein the different levels form a hierarchy of concepts. In this manner, AI model 630 can be configured to differentiate features of interest from background features.

The algorithm 616 can be an organized set of computer-executable operations used to generate output data from a set of input data and can be described using pseudocode. The algorithm 616 can include complex code that allows the computing resources to learn from new input data and create new/modified outputs based on what was learned. In some implementations, the algorithm 616 can build the AI model 630 through being trained while running computing resources of the hardware platform 610. This training allows the algorithm 616 to make predictions or decisions without being explicitly programmed to do so. Once trained, the algorithm 616 can run at the computing resources as part of the AI model 630 to make predictions or decisions, improve computing resource performance, or perform tasks. The algorithm 616 can be trained using supervised learning, unsupervised learning, semi-supervised learning, and/or reinforcement learning.

Using supervised learning, the algorithm 616 can be trained to learn patterns (e.g., map input data to output data) based on labeled training data. The training data can be labeled by an external user or operator. For instance, a user can collect a set of training data, such as by capturing application and/or service usage patterns, metadata, historical communication sessions, and the like (detailed further in FIG. 4 and FIG. 5). The user can label the training data based on one or more classes and trains the AI model 630 by inputting the training data to the algorithm 616. The algorithm determines how to label the new data based on the labeled training data. The user can facilitate collection, labeling, and/or input via the ML framework 614. In some instances, the user can convert the training data to a set of feature vectors for input to the algorithm 616. Once trained, the user can test the algorithm 616 on new data to determine if the algorithm 616 is predicting accurate labels for the new data. For example, the user can use cross-validation methods to test the accuracy of the algorithm 616 and retrain the algorithm 616 on new training data if the results of the cross-validation are below an accuracy threshold.

Supervised learning can involve classification and/or regression. Classification techniques involve teaching the algorithm 616 to identify a category of new observations based on training data and are used when input data for the algorithm 616 is discrete. Said differently, when learning through classification techniques, the algorithm 616 receives training data labeled with categories (e.g., classes) and determines how features observed in the training data (e.g., features of data of FIG. 4 and FIG. 5 such as frequency of data transmissions, duration of data sessions, volume of data exchanges, timing of data bursts) relate to the categories (e.g., services and applications). Once trained, the algorithm 616 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 616 is continuous. Regression techniques can be used to train the algorithm 616 to predict or forecast relationships between variables. To train the algorithm 616 using regression techniques, a user can select a regression method for estimating the parameters of the model. The user collects and labels training data that is input to the algorithm 616 such that the algorithm 616 is trained to understand the relationship between data features and the dependent variable(s). Once trained, the algorithm 616 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 616 learns patterns from unlabeled training data. In particular, the algorithm 616 is trained to learn hidden patterns and insights of input data, which can be used for data exploration or for generating new data. Here, the algorithm 616 does not have a predefined output, unlike the labels output when the algorithm 616 is trained using supervised learning. Another way unsupervised learning is used to train the algorithm 616 to find an underlying structure of a set of data is to group the data according to similarities and represent that set of data in a compressed format. The wireless communication system 300 disclosed herein can use unsupervised learning to identify patterns in data received.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 616 can be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 616 can be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that can be used by the algorithm 616 include factor analysis, item response theory, latent profile analysis, and latent class analysis.

In some implementations, the AI system 600 trains the algorithm 616 of AI model 630, based on the training data, to correlate the feature vector to expected outputs in the training data. As part of the training of the AI model 630, the AI system 600 forms a training set of features and training labels by identifying a positive training set of features that have been determined to have a desired property in question, and, in some implementations, forms a negative training set of features that lack the property in question. The AI system 600 applies ML framework 614 to train the AI model 630, that when applied to the feature vector, outputs indications of whether the feature vector has an associated desired property or properties, such as a probability that the feature vector has a particular Boolean property, or an estimated value of a scalar property. The AI system 600 can further apply dimensionality reduction (e.g., via linear discriminant analysis (LDA), PCA, or the like) to reduce the amount of data in the feature vector to a smaller, more representative set of data.

The model layer 606 implements the AI model 630 using data from the data layer and the algorithm 616 and ML framework 614 from the structure layer 604, thus enabling decision-making capabilities of the AI system 600. The model layer 606 includes a model structure 620, model parameters 622, a loss function engine 624, an optimizer 626, and a regularization engine 628.

The model structure 620 describes the architecture of the AI model 630 of the AI system 600. The model structure 620 defines the complexity of the pattern/relationship that the AI model 630 expresses. Examples of structures that can be used as the model structure 620 include decision trees, support vector machines, regression analyses, Bayesian networks, Gaussian processes, genetic algorithms, and artificial neural networks (or, simply, neural networks). The model structure 620 can include a number of structure layers, a number of nodes (or neurons) at each structure layer, and activation functions of each node. Each node's activation function defines how to node converts data received to data output. The structure layers can include an input layer of nodes that receive input data, an output layer of nodes that produce output data. The model structure 620 can include one or more hidden layers of nodes between the input and output layers. The model structure 620 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 622 represent the relationships learned during training and can be used to make predictions and decisions based on input data. The model parameters 622 can weight and bias the nodes and connections of the model structure 620. For instance, when the model structure 620 is a neural network, the model parameters 622 can weight and bias the nodes in each layer of the neural networks, such that the weights determine the strength of the nodes and the biases determine the thresholds for the activation functions of each node. The model parameters 622, in conjunction with the activation functions of the nodes, determine how input data is transformed into desired outputs. The model parameters 622 can be determined and/or altered during training of the algorithm 616.

The loss function engine 624 can determine a loss function, which is a metric used to evaluate the AI model's 630 performance during training. For instance, the loss function engine 624 can measure the difference between a predicted output of the AI model 630 and the actual output of the AI model 630 and is used to guide optimization of the AI model 630 during training to minimize the loss function. The loss function can be presented via the ML framework 614, such that a user can determine whether to retrain or otherwise alter the algorithm 616 if the loss function is over a threshold. In some instances, the algorithm 616 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 626 adjusts the model parameters 622 to minimize the loss function during training of the algorithm 616. In other words, the optimizer 626 uses the loss function generated by the loss function engine 624 as a guide to determine what model parameters lead to the most accurate AI model 630. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 626 used can be determined based on the type of model structure 620 and the size of data and the computing resources available in the data layer 602.

The regularization engine 628 executes regularization operations. Regularization is a technique that prevents over-and under-fitting of the AI model 630. Overfitting occurs when the algorithm 616 is overly complex and too adapted to the training data, which can result in poor performance of the AI model 630. Underfitting occurs when the algorithm 616 is unable to recognize even basic patterns from the training data such that it cannot perform well on training data or on validation data. The regularization engine 628 can apply one or more regularization techniques to fit the algorithm 616 to the training data properly, which helps constraint the resulting AI model 630 and improves its ability for generalized application. Examples of regularization techniques include lasso (L1) regularization, ridge (L2) regularization, and elastic (L1 and L2 regularization).

In some implementations, the AI system 600 can include a feature extraction module implemented using components of the example computer system 700 illustrated and described in more detail with reference to FIG. 7. In some implementations, the feature extraction module extracts a feature vector from input data. The feature vector includes n features (e.g., feature a, feature b, . . . , feature n). The feature extraction module reduces the redundancy in the input data, e.g., repetitive data values, to transform the input data into the reduced set of features such as feature vector. The feature vector contains the relevant information from the input data, such that events or data value thresholds of interest can be identified by the AI model 630 by using this reduced representation. In some example implementations, the following dimensionality reduction techniques are used by the feature extraction module: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

### Computer System

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer system (SBC), or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”).

The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense-that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number can also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that can be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A system comprising:
at least one hardware processor; and
at least one non-transitory memory storing instructions, which, when executed by the at least one hardware processor, cause the system to:
receive, by a network device in a non-terrestrial network (NTN), information relating to an application or service being used by a terminal device that is in a connected mode with the network device,
wherein the connected mode is managed by a Radio Resource Control (RRC) protocol;
subsequent to receiving the information:
in response to detecting an absence of additional information relating to the application or the service, start, by the network device, an RRC inactivity timer with a time period,
wherein the terminal device remains in the connected mode during the time period, and
wherein the time period of the RRC inactivity timer is based on the application or the service being used by the terminal device; and
in response to the time period of the RRC inactivity timer expiring during the absence of the additional information during the time period, transition the terminal device from the connected mode to an idle mode or an inactive mode with the network device,
wherein the idle mode and the inactive mode are managed by the RRC protocol.

2. The system of claim 1,
wherein the information comprises uplink data transmission of the application or the service,
wherein the uplink data transmission is transmitted from the terminal device to the network device.

3. The system of claim 2,
wherein the additional information comprises additional uplink data transmission of the application or the service,
wherein the additional uplink data transmission is transmitted from the terminal device to the network device.

4. The system of claim 1,
wherein the information comprises a request for downlink data transmission of the application or the service,
wherein the downlink data transmission is transmitted from the network device to the terminal device.

5. The system of claim 4,
wherein the additional information comprises additional downlink data transmission of the application or the service,
wherein the additional downlink data transmission is transmitted from the terminal device to the network device.

6. The system of claim 1, wherein the system is caused to:
manage the connected mode using Frequency Division Duplexing (FDD),
wherein the FDD uses two frequency bands to simultaneously transmit data on a first frequency band and receive the data on a second frequency band, and
wherein the time period of the RRC inactivity timer is based on the two frequency bands.

7. The system of claim 1, wherein the instructions cause the system to:
generate service profiles associated with specific types of applications or specific types of services,
wherein each service profile includes predetermined parameters for adjusting the time period of the RRC inactivity timer based on the associated application or the associated service.

8. A non-transitory, computer-readable storage medium comprising instructions recorded thereon, wherein the instructions when executed by at least one data processor of a computer system, cause the computer system to:
detect, by a network device in a non-terrestrial network (NTN), a Radio Resource Control (RRC) connection between a user equipment (UE) and the network device,
wherein the RRC connection between the UE and the network device is managed by an RRC protocol;
receive, by the network device, uplink data transmitted from an application or service associated with the UE;
determine, by the network device, an absence of additional uplink data from the application or the service associated with the UE;
in response to determining the absence of additional uplink data from the application or the service associated with the UE, initiate, by the network device, an RRC inactivity timer in accordance with the RRC protocol,
wherein the RRC inactivity timer includes an assigned time period, the assigned time period determined based on the application or the service associated with the UE;
monitor, by the network device, expiration of the assigned time period of the RRC inactivity timer without a presence of the additional uplink data from the application or the service; and
in response to the expiration of the assigned time period of the RRC inactivity timer, release, by the network device, the UE from the RRC connection to the network device.

9. The non-transitory, computer-readable storage medium of claim 8, wherein the RRC inactivity timer is a first RRC inactivity timer, wherein the assigned time period is a first assigned time period, wherein the instructions cause the computer system to:
receive, by the network device, a request for downlink data from the application or the service associated with the UE;
in response to receiving the request for the downlink data, transmit the downlink data to the UE;
determine an absence of a request for additional downlink data from the application or the service associated with the UE;
in response to determining the absence of the request for the additional downlink data, initiate a second RRC inactivity timer including a second assigned time period;
monitor an expiration of the second assigned time period of the second RRC inactivity timer without a presence of the request for the additional downlink data; and
in response to the expiration of the second assigned time period of the second RRC inactivity timer, release the UE from the RRC connection to the network device.

10. The non-transitory, computer-readable storage medium of claim 9, wherein the instructions cause the system to:
reduce greenhouse gas emissions of datacenters by reducing (i) electrical power consumption of the UE and (ii) a volume of transmission of additional uplink data and/or additional downlink data between the UE and the network device by releasing the UE from the RRC connection to the network device in response to the expiration of one or more of: (1) the first assigned time period of the first RRC inactivity timer or (2) the second assigned time period of the second RRC inactivity timer.

11. The non-transitory, computer-readable storage medium of claim 8, wherein the instructions cause the system to:
receive burst traffic from the UE,
wherein the burst traffic includes intermittent surges in the uplink data;
in response to receiving the burst traffic, prevent release, by the network device, of the UE from the RRC connection to the network device.

12. The non-transitory, computer-readable storage medium of claim 11, wherein the instructions cause the system to:
communicate with a neighboring network device in the NTN to exchange information related to the received burst traffic of the network device or the neighboring network device;
adjust the RRC inactivity timer based on the exchanged information.

13. The non-transitory, computer-readable storage medium of claim 8, wherein the instructions cause the system to:
generate service profiles associated with specific types of applications or specific types of services,
wherein each service profile includes predetermined parameters for adjusting the assigned time period of the RRC inactivity timer based on the associated application or the associated service.

14. The non-transitory, computer-readable storage medium of claim 8, wherein the instructions cause the system to:
determine the assigned time period of the RRC inactivity timer by employing a machine-learning (ML) model configured to identify patterns in traffic between the network device and the UE;
dynamically adjust the assigned time period of the RRC inactivity timer based on changes in the identified patterns.

15. A method comprising:
receiving, by a network device in a non-terrestrial network (NTN), and from a terminal device being in a connected mode with the network device, information relating to an application or service being used by the terminal device,
wherein the connected mode between the network device and the terminal device is managed by a Radio Resource Control (RRC) protocol;
subsequent to the receiving the information, in response to an absence of additional information relating to the application or the service, starting, by the network device, a RRC inactivity timer with a time period,
wherein the terminal device remains in the connected mode during the time period,
wherein the time period of the RRC inactivity timer is based on the application or the service being used by the terminal device; and
in response to the time period of the RRC inactivity timer expiring without a presence of the additional information during the time period, transitioning the terminal device from the connected mode to an idle mode or an inactive mode with the network device,
wherein the idle mode and the inactive mode are managed by the RRC protocol.

16. The method of claim 15, wherein the information comprises uplink data transmission of the application or the service, the method comprising:
transmitting the uplink data transmission from the terminal device to the network device.

17. The method of claim 15, wherein the information comprises a request for downlink data transmission of the application or the service, the method comprising:
transmitting the downlink data transmission from the network device to the terminal device.

18. The method of claim 15, comprising:
generating service profiles associated with specific types of applications or specific types of services,
wherein each service profile includes predetermined parameters for adjusting the time period of the RRC inactivity timer based on the associated application or the associated service.

19. The method of claim 18, comprising:
receiving burst traffic, by the network device, from the terminal device,
wherein the burst traffic includes intermittent surges in the information received;
communicating with a neighboring network device in the NTN to exchange information related to the received burst traffic of the network device or the neighboring network device;
adjusting the RRC inactivity timer based on the exchanged information.

20. The method of claim 15,
wherein the connected mode between the terminal device and the network device is directed by Frequency Division Duplexing (FDD),
wherein the FDD uses two frequency bands to simultaneously transmit data on a first frequency band and receive the data on a second frequency band, and
wherein the time period of the RRC inactivity timer is based on the two frequency bands.
